(19) United States
(12) Patent Application Publication
(10) Pub. No.: US 2015/0070213 A1
(43) Pub. Date: Mar. 12, 2015

(54) LOCATION DETERMINATION IN MULTI-SYSTEM GNNS ENVIRONMENT USING CONVERSION OF DATA INTO A UNIFIED FORMAT

(71) Applicants: FURUNO ELECTRIC COMPANY, LTD., NISHINOMIYA CITY (JP); ERIDE, INC., SAN BRUNO, CA (US)

(72) Inventors: SHAHRAM REZAEI, Danville, CA (US); Paul W. McBurney, Palo Alto, CA (US)

(73) Assignees: FURUNO ELECTRIC COMPANY, LTD., NISHINOMIYA CITY (JP); ERIDE, INC., SAN BRUNO, CA (US)

(21) Appl. No.: 14/025,547

(22) Filed: Sep. 12, 2013

(51) Int. Cl. G01S 19/27; G01S 19/25

(52) U.S. Cl. CPC G01S 19/27; G01S 19/258
USPC 342/357.66

(57) ABSTRACT

Accurate long term satellite models for satellites include satellites of different navigation systems. Such a model is derived for a non-GPS satellite that broadcasts native orbital model data specified as valid within a first time period. Initial position and velocity data are determined from the native orbital model data, and orbit integration is performed to determine an orbital arc in an earth-centered-earth-fixed frame over a second time period longer than the first time period. Initial estimates of GPS or GPS-like orbit parameters are determined for the non-GPS satellite, and the orbital arc and the initial estimates of the GPS or GPS-like orbit parameters are input to an orbit parameter solver that determines GPS or GPS-like parameters that fit the orbital arc and is used to determine final orbital model parameters in GPS or GPS-like format for the non-GPS satellite.

### BACKGROUND OF THE INVENTION

1. Field of the Invention

The present invention relates to satellite navigation receivers.

2. Description of the Prior Art

Mobile phones, tablets, digital cameras, and many other electronic devices now come routinely equipped with GNSS (Global Navigation Satellite System) receivers that provide position fixes for their users. GNSS refers generically to satellite based navigation systems. GNSS may comprise several systems that are currently operational or in development. The United States' Global Positioning System (GPS) is the oldest system and currently the main system. Most of the existing GNSS receivers only support GPS system and are simply called GPS receiver. Russia's Glonass system is the only alternative navigational system in operation with global coverage and of comparable precision. Europe is building its own GALILEO system and so are few other countries, including Japan (QZSS), India (Galan), and China (Beidou).

In the GPS system, thirty-two satellites circling the earth at an altitude of 20,200 km with a 55 degree inclination and a period of 11 hours and 58 minutes. They are spaced in orbit such that a minimum of six satellites are in view at any one time to a user.

Glonass satellites are located in a middle circular orbit at 19,100 km altitude with a 65 degree inclination and a period of 11 hours and 15 minutes. By 2010, Glonass had achieved 100% coverage of Russia's territory and in October 2011, the full orbital constellation of 24 satellites was achieved, enabling full global coverage. Glonass' orbit (higher inclination angle than GPS by about 10 degrees) makes it especially suited for usage in high latitudes (north or south), where getting a GPS signal can be problematic. The constellation operates in three orbital planes, with eight evenly spaced satellites on each. A fully operational constellation with global coverage consists of 24 satellites, while 18 satellites are necessary for covering the territory of Russia.

Each GNSS satellite transmits an accurate time and position signal. GNSS receivers measure the time delay for the signal to reach it, and the apparent receiver-satellite distance is calculated from that. Measurements like this from at least four satellites allow a GNSS receiver to calculate its three-dimensional position, velocity, and system time.

The solution to the receiver position depends on knowing where each of the relevant satellites is in three-dimensional space. The respective positions are reported as parameters belonging to a set of equations that are quite different between GPS and Glonass systems. In conventional GPS systems, the GPS ephemeris includes all the items in Table I. An orbital model that includes most or all of the parameters of Table I is referred to herein as a GPS or GPS-like orbital model. Glonass ephemeris data includes satellite's position and velocity data in Cartesian XYZ PZ-90 coordinate system. In conventional Glonass systems, the Glonass ephemeris includes all the items in Table II.

TABLE I
GPS Ephemeris Message

| Name | Symbol |
|---|---|
| Reference time of ephemeris | toe |
| Square root of semi major axis | \sqrt{a} |
| Eccentricity | e |
| Inclination angle (at time toe) | i0 |
| Longitude of ascending node | Ω₀ |
| Argument of perigee (at time toe) | w |
| Mean anomaly (at time toe) | M0 |
| Rate of change of inclination angle | di/dt |
| Rate of change of Longitude of ascending node | \dot{Ω} |
| Mean motion correction | Δn |
| Amplitude of cosine correction to argument of | Cuc |
| latitude | |
| Amplitude of sine correction to argument of | Cus |
| latitude | |
| Amplitude of cosine correction to orbital radius | Crc |
| Amplitude of sine correction to orbital radius | Crs |
| Amplitude of cosine correction to inclination | Cic |
| angle | |
| Amplitude of sine correction to inclination angle | Cis |

TABLE II
GlonassNative Orbital Model Data Message
(Analogous to Ephemeris)

| Name | Symbol |
|---|---|
| Reference time of ephemeris in UTC time | toe |
| coordinate | |
| Position along X axis in kilometers | Px |
| Position along Y axis in kilometers | Py |
| Position along Z axis in kilometers | Pz |
| Velocity along X axis in kilometers per second | Vx |
| Velocity along Y axis in kilometers per second | Vy |
| Velocity along Z axis in kilometers per second | Vz |
| Acceleration along X axis in kilometers per | Ax |
| second squared | |
| Acceleration along Y axis in kilometers per | Ay |
| second squared | |
| Acceleration along Z axis in kilometers per | Az |
| second squared | |
| Clock bias in seconds | b |
| Health information | H |

The PZ-90 coordinate system is similar to the WGS-84 (World Geodetic System) coordinate system, which is used by GPS, Galileo and some other GNSS systems. As of Sep. 17, 2007 the PZ-90 datum had been updated to differ from WGS-84 by less than 40 cm (16 in) in any given direction.

During the period of validity of the ephemeris message, it is possible to compute the near exact position and velocity of a satellite and its clock (time) offset at any one instant in its flight using the complete satellite ephemeris message information downloaded to the navigation receiver. The computed positions of the GPS satellites are very sensitive to small variations of most of these parameters, so it is necessary to fully communicate them during each ephemeris download.

It takes a GNSS navigation receiver a minimum of 12.5 minutes of continuous operation for GPS and 2.5 minutes of continuous operation for Glonass to be able to collect the complete almanac and ephemeris data describing all the orbiting satellites and their trajectories. The signal strength at the receivers must also be good in order to be able to demodulate the navigation data sub-carriers. A lack of time and/or a lack of strong signal can frustrate a user trying to get a quick first position fix.

Currently, Glonass satellites broadcast a new ephemeris every thirty minutes, and the time-of-ephemeris is fifteen minutes in the future at the cutover to the new model. The Glonass ephemeris model is valid only for +/−15 minutes around its reference time, according to the Glonass ICD. During the validity time interval of the ephemeris model, position accuracy of the model is better than a few meters. However, this error grows significantly over time, if the model is used beyond the validity time interval.

To calculate a Glonass satellite's position and velocity information at a time ‘t’, using a Glonass ephemeris model, orbit of the satellite has to be integrated from reference time ‘t0’ of the model up to ‘t’ with a force model that is not described in the broadcast ephemeris format of Table II but is described in the publicized Glonass Interface Control Document (ICD). On the contrary, a GPS ephemeris model's calculation can be computed at anytime independently, or as a snapshot calculation, without the need to integrate from the reference time to the desired time.

The GPS system is the system of use in nearly all existing satellite based positioning receivers. Other systems, including Glonass, are gradually (as they become available for public use) being added into the receivers, in order to improve reliability and positioning accuracy. In general, having access and using signals from more satellites results in better position and velocity accuracy.

### SUMMARY OF THE INVENTION

Accurate long term satellite models for satellites include satellites of different navigation systems, for example GPS satellites and Glonass satellites. An accurate long-term orbital model is derived for a non-GPS satellite that broadcasts native orbital model data specified as valid within a first time period. Initial position and velocity data are determined from the native orbital model data, and orbit integration based on a force model is performed to determine an orbital arc in an earth-centered-earth-fixed frame over a second time period longer than the first time period. Initial estimates of GPS or GPS-like orbit parameters are determined for the non-GPS satellite, and the orbital arc and the initial estimates of the GPS or GPS-like orbit parameters are input to an orbit parameter solver that determines GPS or GPS-like parameters that fit the orbital arc. The orbit parameter solver is used to determine final orbital model parameters in GPS or GPS-like format for the non-GPS satellite. More particularly, forced-based estimates of GPS orbit parameters are estimated based on the initial estimates.

Converting a Glonass satellite ephemeris navigation model into a Unified GPS ephemeris format in many instances improves time to first fix of GNSS receiver and improves tracking sensitivity in weak signal environments as a single observation of the broadcast ephemeris can be used much longer than the time available with the native model. Efficiency is achieved by representing all satellite models in a unified format, preferably the GPS ephemeris format.

Embodiments of the present invention include an electronic device including a GNSS receiver able to collect Glonass ephemeris information from orbiting Glonass satellites and to use that information to build up modified Glonass ephemeris model in the unified format that will be valid and useful for several orders of magnitude longer than the original validity time period of Glonass ephemeris model. Advantages include reducing time to first fix, extending the validity time of Glonass ephemeris, and simplifying the GNSS receiver's software design by enabling it to do all navigation model computation in GPS ephemeris format.

Embodiments of the invention also include non-transitory computer-readable media bearing instructions for performing methods as described above.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1A is a functional block diagram of a system embodiment of a mobile electronic device incorporating a GNSS receiver;

FIG. 1B is another diagram of the mobile electronic device of FIG. 1A;

FIG. 2 is a flow chart of a method for constructing a unified satellite ephemeris model applicable to GPS satellites, Glonass satellites, etc.;

FIG. 3 is a flow chart of a method for converting orbit integration position samples into a GPS ephemeris navigation model;

FIG. 4 is a plot of position error over time for a first Glonass satellite using an orbital model based solely on Glonass ephemeris data;

FIG. 5 is a plot of position error over time for a second Glonass satellite using an orbital model based solely on Glonass ephemeris data;

FIG. 6 is diagram illustrating concepts of radial error and maximum observable error;

FIG. 7 is a plot of position error over time for a first Glonass satellite using a unified orbital model as described herein; and

FIG. 8 is a plot of position error over time for a second Glonass satellite using a unified orbital model as described herein.

### DETAILED DESCRIPTION OF THE PREFERRED EMBODIMENT

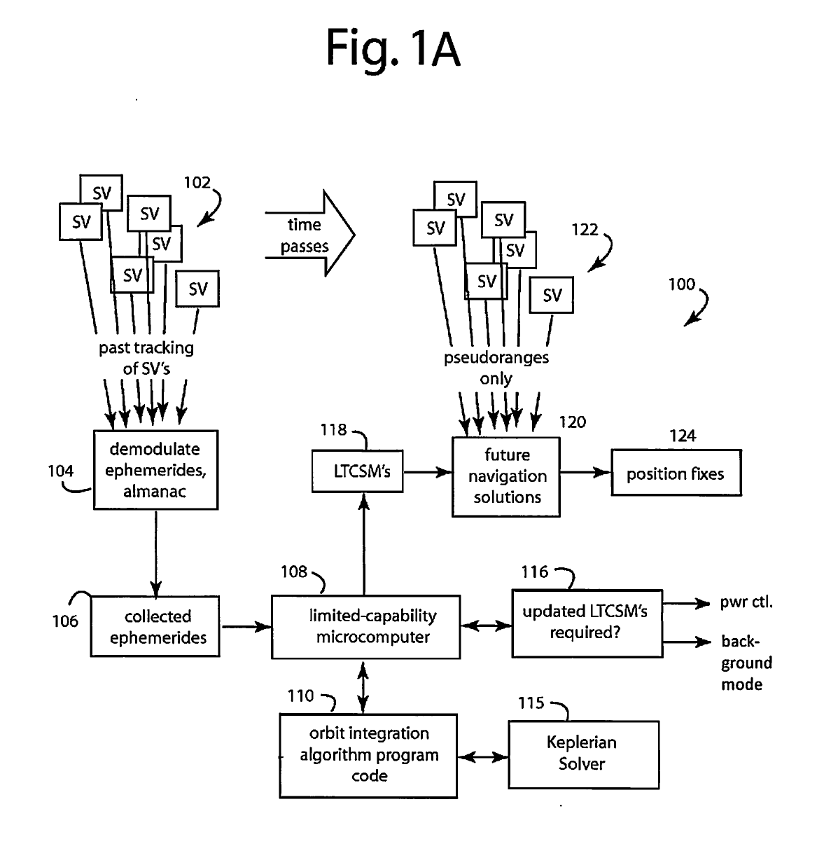

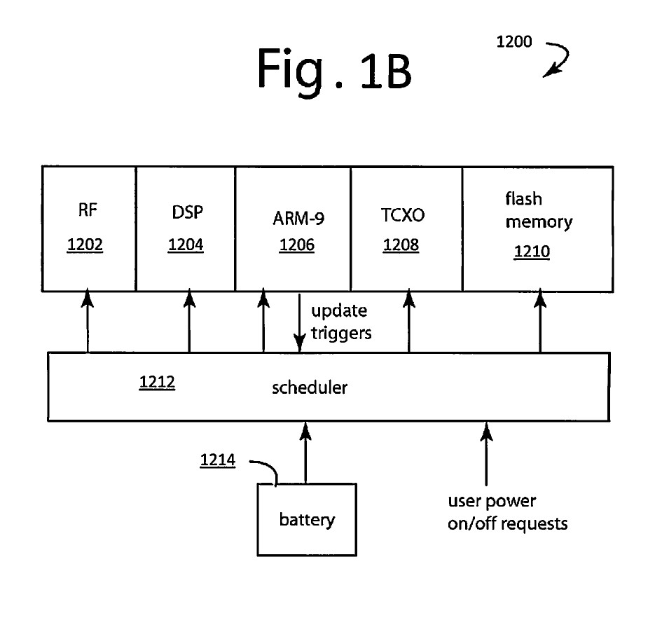

Referring now to FIG. 1A, a diagram is shown of an electronic device, such as a mobile electronic device, a server-based system, etc., having extended ephemeris satellite navigation capabilities, referred to herein by the general reference numeral 100. Over time, continually varying constellations of all the orbiting satellite vehicles (SV's) 102 transmit microwave signals that include their then-up-to-date respective ephemerides. A processor 104 demodulates these ephemerides (and/or the almanacs that include them) opportunistically over time (over days or even weeks). The processor 104 may be part of a mobile electronic device, or may be in communication with a server-based system. A complete collection 106 of the ephemerides and the almanacs may then be made available on an on-going basis to a microcomputer 108.

The satellite vehicles 102 may belong to different satellite navigations systems, e.g., GPS, Glonass, etc. Navigation Messages transmitted by the SVs 102 will be different depending on the navigation system.

An orbit integration algorithm program 110 is provided to the microcomputer 108. In an exemplary embodiment, for a particular satellite, the orbit integration algorithm program code applies a corresponding force model to project collected ephemeris data out into the future. In an exemplary embodiment, only a single observation of the ephemeris for each SV is used in each of the corresponding SV-projections, e.g., the last good ephemeris demodulated and verified for that SV. Such an approach reduces the computational load and more importantly, reduces the amount of time a receiver must be powered on and collecting ephemeris. Such a single point observation nevertheless provides high quality extended ephemeris information that can be useful 7-10 days into the future.

Referring still to FIG. 1A, a Keplerian Solver 115, also referred to herein as an orbit parameter solver, provides the executable program code that is needed by the microcomputer 108 to compute estimates for the fifteen Keplerian parameters in TABLE I above.

In an exemplary embodiment, these parameters are computed to best fit a series of satellite X-Y-Z position samples in the ECEF coordinate system. The components of vector X are related to known position components X-Y-Z using conventional non-linear ephemeris equations. In an exemplary embodiment, the non-linear ephemeris equations are then linearized using a finite-order Taylor Series to find linear equations that will relate the Keplerian parameters to each X-Y-Z position. Then a standard Least Squares method is used to solve the Keplerian parameters.

In an exemplary embodiment, the Keplerian Solver program code 115 therefore converts orbital samples in the form of X-Y-Z satellite positions in the ECEF frame into ephemerides. In an exemplary embodiment, the ephemerides it outputs will each be valid for a period of hours, e.g., four hours before its computed time-of-ephemeris (TOE) and four hours after the TOE so that the TOE is centered in the usability region similar to the broadcast TOE

The Keplerian Solver program code 115 can commence operation after only a single observation of the ephemeris has been obtained for each corresponding SV 102. As little as one X-Y-Z position sample per hour is all that is necessary to support the functioning. This means for an eight hour model, no more than nine samples are needed per SV 102.

The orbital models obtained from the results of the Keplerian Solver may be stored in the form of Long-Term Compact Satellite Models (LTCSMs). An updating process 116 may schedule when processing time on the microcomputer 108 should be used to compute new LTCSM's. Such LTCSM processing can be in background while normal position solutions are actively being provided to a user, or as a residual process that continues after the user requests a power shut down. The updating process 116 can also give priority to building models to optimize LTCSM availability at some expected time in the near future.

An LTCSM library 118 is thus built up and maintained to support future navigation solution processing 120. Flash memory can be used as a storage device for the LTCSM library 118. Typically, such LTCSM library 118 will eventually have a functional LTCSM saved for each and every SV in a future constellation of SV's 122 that will present itself in the next several days. Using the LTCSM library, position fixes 124 may be computed without having immediate access to anything more than the pseudoranges from SVs 122. The navigation messages of the SVs need not be demodulatable, and so a high sensitivity mode of operation is therefore also enabled. A fast time-to-first-fix (TTFF) and a higher availability of location determination is an important advantage as the location can be determined long after the broadcast data was demodulated in case the satellite signal can still be tracked but the signal is too weak to allow demodulation of the broadcast ephemeris.

Regarding the LTCSM library 118, typically no one long-term model can be used to describe the satellite orbit or clock for an entire week into the future with sufficient accuracy for position fixing. Therefore, the period of a week into the immediate future may be divided into segments, e.g., three, eight-hour segments for each of seven days with a one hour buffer at the beginning and the end, i.e., twenty-one ten-hour long-term models 33 for every possible GPS satellite.

Referring now to FIG. 1B, a mobile electronic device 1200, like that of FIG. 1A, including navigation satellite receiver capabilities, includes a radio frequency (RF) stage 1202, a digital signal processing (DSP) stage 1204, a processor core 1206, a temperature controlled crystal oscillator (TCXO) 1208, and a flash memory 1210. All of these may have their operating power separately controlled by a scheduler 1212 in response to user on/off power requests. In mobile type receivers, a battery 214 supplies all of the operating power. The scheduler 1210 may be directed by an updating process 116 (FIG. 1A).

Further details of an exemplary embodiment of the system of FIG. 1A and FIG. 1B are described in McBurney et al., U.S. Patent Publication 20120056782, application Ser. No. 12/874,904, Satellite Navigation Receivers With Self-Provided Future Ephemeris and Clock Predictions, filed Sep. 2, 2010, incorporated herein by reference.

As described above, the satellite vehicles may belong to different satellite navigations systems, e.g., GPS, Glonass, etc. Navigation Messages transmitted by the SVs 102 will be different depending on the navigation system.

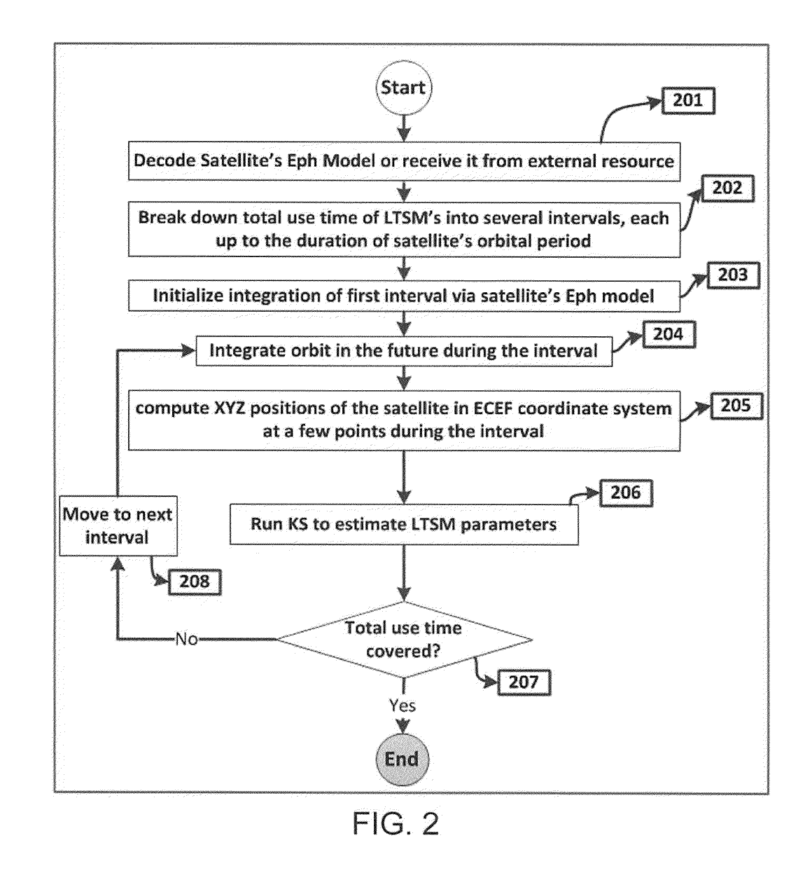

FIG. 2 is a flow chart diagram of generating Glonass navigation models in a unified format, sometimes referred to herein as the unified ephemeris model. In step 201, Glonass ephemeris navigation model is decoded from the sky or received from an external source, such as a server or the internet.

In step 202, a desired validity time of the unified models is broken down into several intervals, each equal to X number of hours, for example 8 hours. Practically, the length of each interval should not be longer than orbital period of the satellite (i.e. about 12 hours).

In one embodiment, for each interval, or for each of multiple successive time periods, orbit integration is performed over the time period. The Keplerian solver is initialized with an initial estimate of the Keplerian orbital model parameters obtained from a preceding time period. Orbit integration data for the time period is input to the Keplerian solver, which is used to obtain Keplerian orbit model parameters for the time period. In this manner, multiple orbital model parameter sets are “chained together” to form an overall orbital model parameter set of extended duration.

In steps 203 and 204, the orbit of the satellite is integrated between start and end time of the interval. End point of an interval is the start point of the next one (if any). The very first interval may be initialized using position and velocity data of the Glonass ephemeris model. The step size of the integration (time interval between orbit integration data points) may be fixed or varying with time, typically in the order of seconds. A larger step size results in faster integration, but produces larger integration errors.

Although the step size of the integration should be selected to be small enough to reduce the integration errors, only a few of the orbit samples are required for deriving the unified ephemeris model. In step 205, a few orbit samples, one sample for every hour or so, are converted into ECEF (WGS-84) coordinate system. These samples are inputs to the Keplerian Solver (KS) in step 206.

The program checks in Step 207 if there are any more models that have to be built to cover the desired use time of a long term satellite model. If so, the program moves to next model in step 208 and then repeats steps 204 to 207, otherwise it ends.

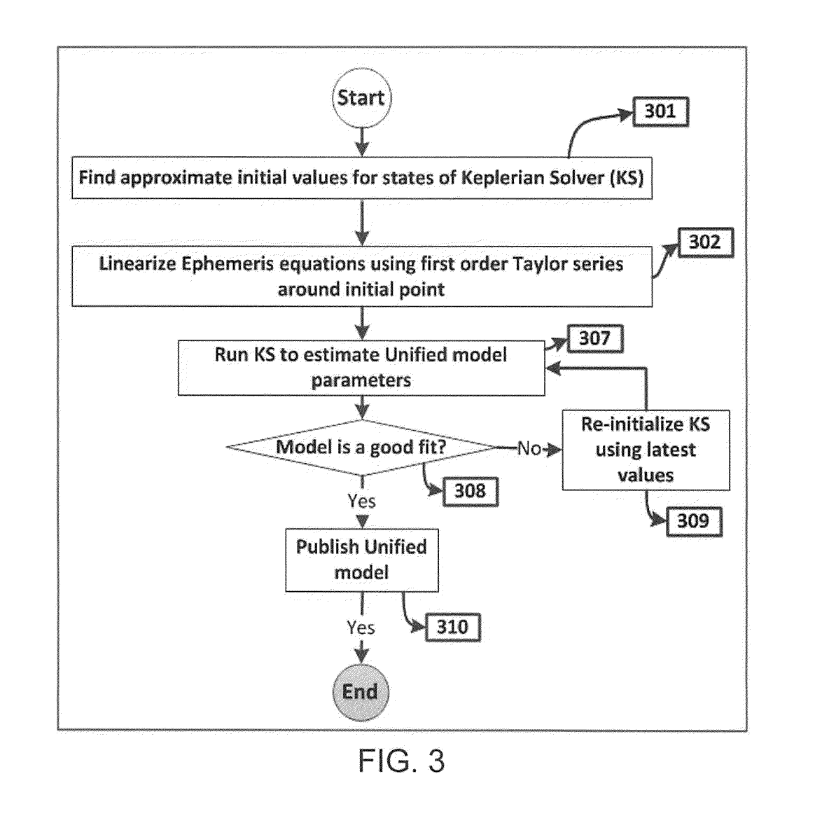

FIG. 3 is a flow chart diagram of converting orbit integration samples into the unified ephemeris model. KS (115 in FIG. 1A) is a least square Keplerian Solver (referred to as KS) that finds the values of 15 unknowns. The unknowns are the parameters of the long term satellite model in GPS ephemeris format, hence the following parameters:

\vec{E}=[a,e,i₀,M₀,Δn,iDot,ω,Ω₀,\dot{Ω},Crs,Crc,Cus,Cuc,Cis,Cic]^{T} (1)

In step 301, KS parameters are initialized using the Glonass satellite's ephemeris model data. This step is necessary in that KS will only converge and produce a reasonably accurate model, if initial values for states of KS are close enough to their true values. A method to find these initial values using position and velocity data of the reference Glonass ephemeris model is described in the following paragraphs. These states could also be estimated using Keplerian parameters obtained from Glonass non-native data messages, also referred to herein as Glonass Almanac model data.

The Glonass Almanac model for a satellite consists of several parameters that include: time in UTC, correction to GPS time relative to GLONASS time, longitude of the first ascending node of the satellite orbit in PZ-90 coordinate system, time of the first ascending node passage of the satellite, correction to the mean value of orbit inclination angle, correction to the mean value of Draconian period of the satellite, rate of change of Draconian period of the satellite, eccentricity, and argument of perigee. From these parameters, the first nine parameters in equation (1) may be derived using techniques available in various Orbital mechanics textbooks and provided in the Glonass ICD document. The remaining six correction parameters may be set to zero.

In step 302, GPS ephemeris equations are linearized using first order Taylor series method around initial values of KS parameters.

In step 307, the following KS' equation is solved. The KS' equation is formed as following:

\vec{Y}= H̅\vec{X}→\vec{X}=( H̅^{T} H̅)⁻¹ H̅\vec{Y}

\vec{E}=\vec{E}₀+\vec{X} (2)

where, vector Y consists of satellite's XYZ position data of the integrated orbit in ECEF coordinate system, between time t₁ to tₙ, as shown below:

$$\vec{Y} = [ \begin{matrix}{P}_{x} ( {t}_{1} ) \\ {P}_{y} ( {t}_{1} ) \\ {P}_{z} ( {t}_{1} ) \\ ⋮ \\ {P}_{x} ( {t}_{n} ) \\ {P}_{y} ( {t}_{n} ) \\ {P}_{z} ( {t}_{n} )\end{matrix} ] \qquad ( 3 )$$

Matrix H contains partial derivatives of GPS ephemeris equations for calculating position and velocity of satellite in the ECEF coordinate system. These equations are listed below:

tₖ=t−tₒₑ Time from ephemeris reference epoch

tₖ=tₖ+(wkn−wknₒₑ)*604800

Mₖ=M₀ntₖ

Mₖ=Eₖ−e sin Eₖ

sin vₖ=\sqrt{1−e²}sin Eₖ/(1−e cos Eₖ)

cos vₖ=(cos Eₖ−e)/(1−e cos Eₖ)

sin Φₖ=sin vₖ cos ω+cos vₖ sin ω

cos Φₖ=cos vₖ cos ω−sin vₖ sin ω

sin 2Φₖ=2 cos Φₖ sin Φₖ

cos 2Φₖ=cos²Φₖ−sin² Φₖ

δuₖ=Cᵤₛ sin 2Φₖ+Cᵤₛ cos 2Φₖ

δrₖ=Cᵣₛ sin 2Φₖ+C_{rc} cos 2Φₖ

δiₖ=Cᵢₛ sin 2Φₖ+C_{ic} cos 2Φₖ

sin uₖ=sin Φₖ cos δuₖ+cos Φₖ sin δuₖ

cos uₖ=cos Φₖ cos δuₖ−cos Φₖ cos δuₖ

rₖ=A(1−e cos Eₖ)+δrₖ

iₖ=i₀+δiₖ+(IDOT)tₖ

x′ₖ=rₖ cos uₖ x position in orbital plane

y′ₖ=rₖ sin uₖ y position in orbital plane

Ωₖ=Ω₀−\dot{Ω}tₒₑ+(\dot{Ω}−\dot{Ω}ₑ)t

Pₓₖ=x′ₖ cos Ωₖ−y′ₖ cos iₖ sin Ωₖ

P_{yk}=x′ₖ sin Ωₖ+y′ₖ cos iₖ cos Ωₖ ECEF coordinates for position

P_{zk}=y′ₖ sin iₖ

The above non-linear equations are differentiated with respect to each of the 15 ephemeris parameters to form elements of matrix H, as follows:

$$\overline{H} = [ \begin{matrix}\frac{\partial {P}_{x}}{\partial a} ( {t}_{1} ) & \frac{\partial {P}_{x}}{\partial e} ( {t}_{1} ) & \frac{\partial {P}_{x}}{\partial i 0} ( {t}_{1} ) & … & \frac{\partial {P}_{x}}{\partial Cic} ( {t}_{1} ) \\ \frac{\partial {P}_{y}}{\partial a} ( {t}_{1} ) & \frac{\partial {P}_{y}}{\partial e} ( {t}_{1} ) & \frac{\partial {P}_{y}}{\partial i 0} ( {t}_{1} ) & … & \frac{\partial {P}_{y}}{\partial Cic} ( {t}_{1} ) \\ \frac{\partial {P}_{z}}{\partial a} ( {t}_{1} ) & \frac{\partial {P}_{z}}{\partial e} ( {t}_{1} ) & \frac{\partial {P}_{z}}{\partial i 0} ( {t}_{1} ) & … & \frac{\partial {P}_{z}}{\partial Cic} ( {t}_{1} ) \\ ⋮ & ⋮ & ⋮ & ⋱ & ⋮ \\ \frac{\partial {P}_{x}}{\partial a} ( {t}_{n} ) & \frac{\partial {P}_{x}}{\partial e} ( {t}_{n} ) & \frac{\partial {P}_{x}}{\partial i 0} ( {t}_{n} ) & … & \frac{\partial {P}_{x}}{\partial Cic} ( {t}_{n} ) \\ \frac{\partial {P}_{y}}{\partial a} ( {t}_{n} ) & \frac{\partial {P}_{y}}{\partial e} ( {t}_{n} ) & \frac{\partial {P}_{y}}{\partial i 0} ( {t}_{n} ) & … & \frac{\partial {P}_{y}}{\partial Cic} ( {t}_{n} ) \\ \frac{\partial {P}_{z}}{\partial a} ( {t}_{n} ) & \frac{\partial {P}_{z}}{\partial e} ( {t}_{n} ) & \frac{\partial {P}_{z}}{\partial i 0} ( {t}_{n} ) & … & \frac{\partial {P}_{z}}{\partial Cic} ( {t}_{n} )\end{matrix} ]$$

In equation (2), vector E₀ contains initial values for the KS' unknown parameters. These initial values should be reasonably close to true values of the unknowns, otherwise the KS will not converge, even after many iterations. In case of GPS, parameters of the satellite's ephemeris model are used to set the values of the parameters of vector E₀. But this is not possible for Glonass, because its ephemeris data is not in GPS format.

In an exemplary embodiment, the initialization of Keplerian Solver for Glonass satellite, step 301, involves the following steps:
1. Use satellites' position and velocity data provided in the Glonass ephemeris model to set the following position and velocity vectors in ECEF (Earth Centered Earth Fixed, which is the same as WGS-84) coordinate system:

\vec{r}_{ECEF}=(Pₓ,P_{y},P_{z})_{GLO Ephemeris}

\vec{v}_{ECEF}=(Vₓ,V_{y},V_{z})_{GLO Ephemeris} (5)
2. Transform above vectors to ICRF (Inertial Celestial Reference Frame) coordinate system, which unlike ECEF does not rotate with Earth (one cycle in about 24 hours). The method of transformation between ECEF to ICRF is available in orbital mechanics textbooks, for example:
   Title: GPS Satellite Surveying
   Author: Alfred Leick

\vec{r}=\vec{r}_{ICRF}=(X,Y,Z)

\vec{v}=\vec{v}_{ICRF}=(\dot{X},\dot{Y},Ż) (6)
3. Compute five parameters a, e, i, w, and M0 of vector E₀, using equations below:
   Eccentricity (e):

$$\vec{h} = \vec{r} \times \vec{v} \\ \vec{e} = \frac{1}{μ} ( \vec{v} \times \vec{h} ) - \frac{\vec{r}}{r} \\ e = \vert \vec{e} \vert \\ μ = 3.986005 \times {10}^{- 5} \frac{{m}^{3}}{{s}^{2}} \qquad ( 7 )$$

Where, μ is the Earth's gravitational constant.
Semi-major Axis (a):

$$a = \frac{\vec{h} \cdot \vec{h}}{μ ( 1 - {e}^{2} )} \qquad ( 8 )$$

Inclination angle (i0):

$${i}_{0} = {cos}^{- 1} ( \frac{\hat{k} \cdot \vec{h}}{\vert \vec{h} \vert} ) \qquad ( 9 )$$

Argument of perigee (w):

$$w = {cos}^{- 1} ( \frac{\vec{n} \cdot \vec{e}}{\vert \vec{n} \vert e} ) \qquad ( 10 )$$

Mean anomaly (M0):

$$θ = {cos}^{- 1} ( \frac{\vec{e} \cdot \vec{r}}{e \times r} ) \\ E = {cos}^{- 1} ( \frac{e + cos ( θ )}{1 + e \times cos ( θ )} ) \\ M 0 = E - e \times sin ( θ ) \qquad ( 11 )$$

4. Compute Δn using equation below:

$$Δ n = \frac{\sqrt{μ}}{{a}^{3}} \qquad ( 12 )$$

5. Set iDot and \dot{Ω} to zero. Also set six correction terms Cᵣₛ, C_{rc}, C_{Us}, C_{uc}, Cᵢₛ, C_{ic} to zero.
6. At this point, the only remaining parameter to be set is Ω₀. The best value of Ω₀ may be computed by checking all possible angle values between 0 to 360 degrees, with a fine resolution of one degree or so. The best value is one that results in minimum total position error at the time of Glonass Ephemeris (TOE), using the complete set of estimated KS parameters to form a GPS-like satellite ephemeris model. This model is used to calculate the satellite's position in ECEF coordinates at TOE, which is then compared with corresponding values provided by the Glonass ephemeris model to compute a position error vector. The absolute value of this position error vector is taken to be total position error. In other words, for each candidate value of Ωₒ, the KS is run to obtain a candidate GPS-like satellite ephemeris model which is evaluated by comparing the satellite position at TOE as determined using the candidate model, or parameter set, and the satellite position at TOE as determined using the Glonass ephemeris model. The candidate model yielding the smallest error is chosen.

In step 308, differences between orbit integration position samples and equivalent ones from the computed Keplerian unified model are calculated; if the unified model is a good fit for the data, then model is outputted, otherwise step 309 is executed. In this step, states of the KS are re-initialized using their latest values as output at step 307, then steps 307 and 308 are repeated, until the condition of step 308 is satisfied. In practice, usually just one iteration results satisfies the condition. The resulting unified model may then be published (step 310), i.e., made available for use in determining location.

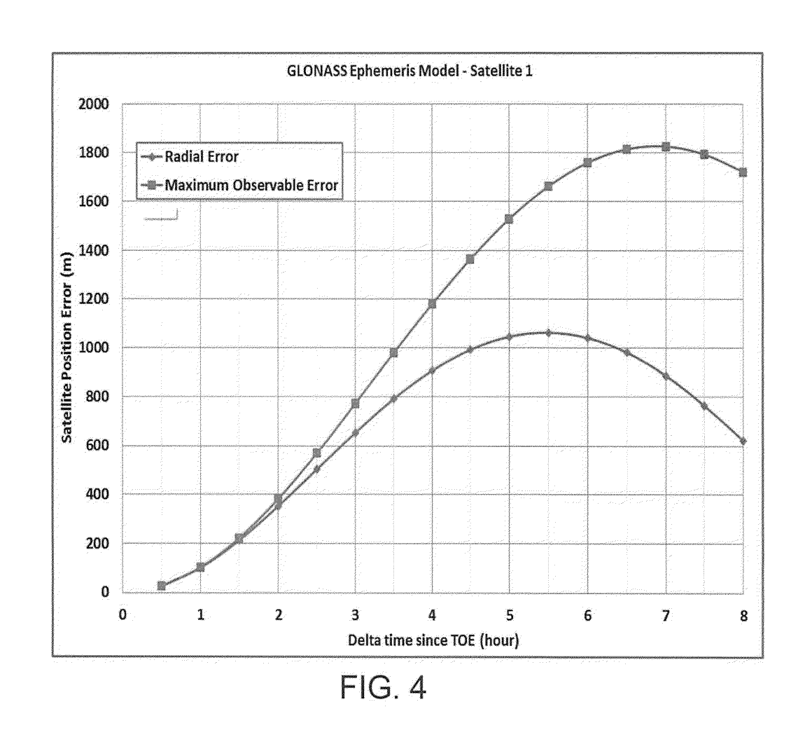

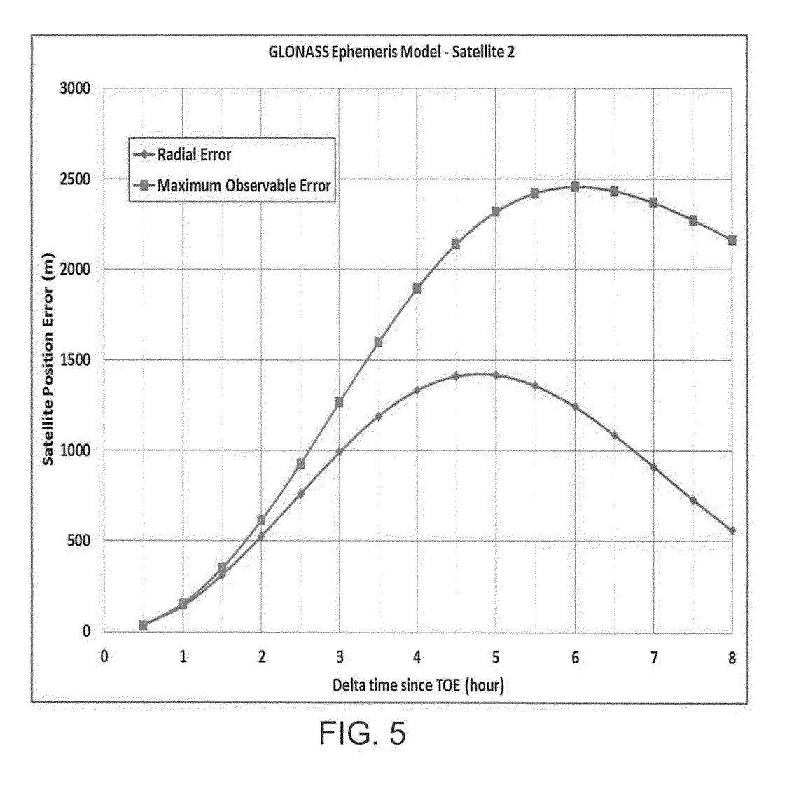

Glonass unified navigation models, derived using the method presented herein, have a much longer validity time (on the order of a few hours or days) than the conventional Glonass ephemeris model (just plus or minus 15 minutes from TOE). FIG. 4 and FIG. 5 show typical position accuracy of Glonass ephemeris models for two satellites for eight hours, which is beyond their designed use time of 15 minutes (as suggested by Glonass ICD). In FIG. 4 and FIG. 5, Glonass ephemeris models are for satellite indices (or known as slot number) 1 and 2 at Mar. 20, 2013, 03:45 GMT. As seen, errors grow to several kilometers, which is too inaccurate for a GNSS receiver and could not be used to produce a fix. The unified navigation models thus extend the availability of location determination in case newer models cannot be collected, due to any number of conditions such as infrequent tracking, or signals too weak allow demodulation of broadcast data.

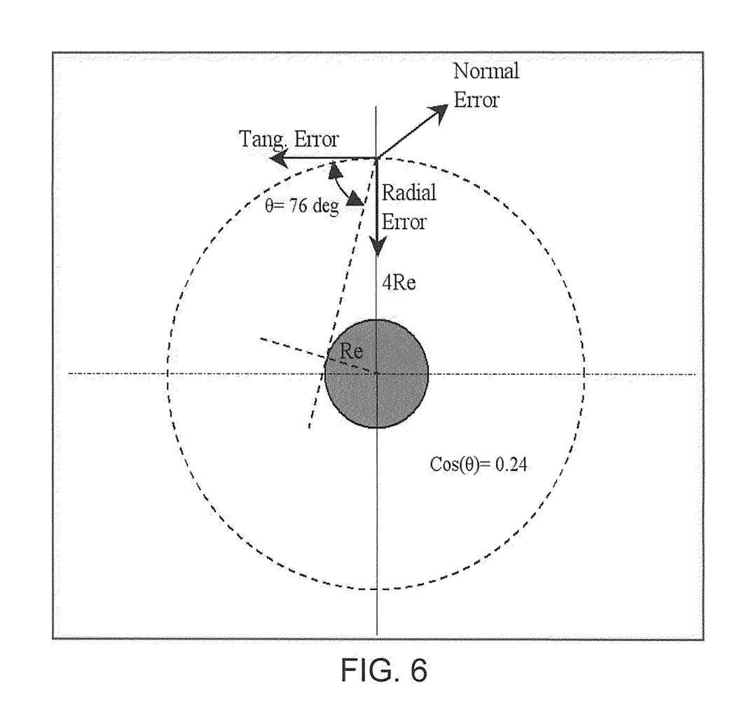

In FIG. 4 and FIG. 5, ‘Radial Error’ refers to error along the direction between center of Earth and satellite; ‘Maximum Observable Error’ is the radial error plus 25% of the remaining position error in the plane perpendicular to the radial direction, as shown in FIG. 6. Error is defined as difference between position data from a valid Glonass ephemeris model at the time and the corresponding position data derived from integrating the orbit using either the ICD method or the Unified ephemeris method.

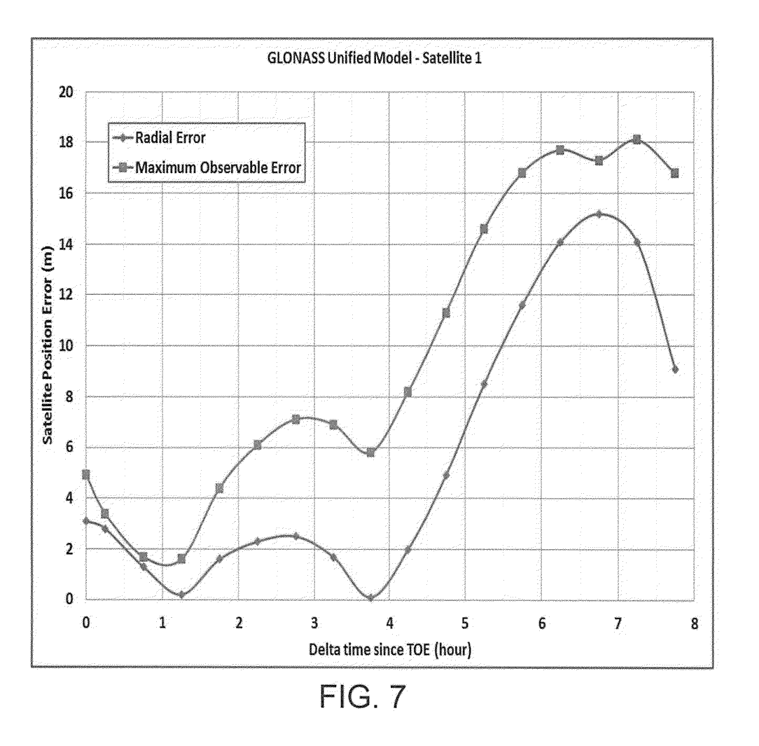

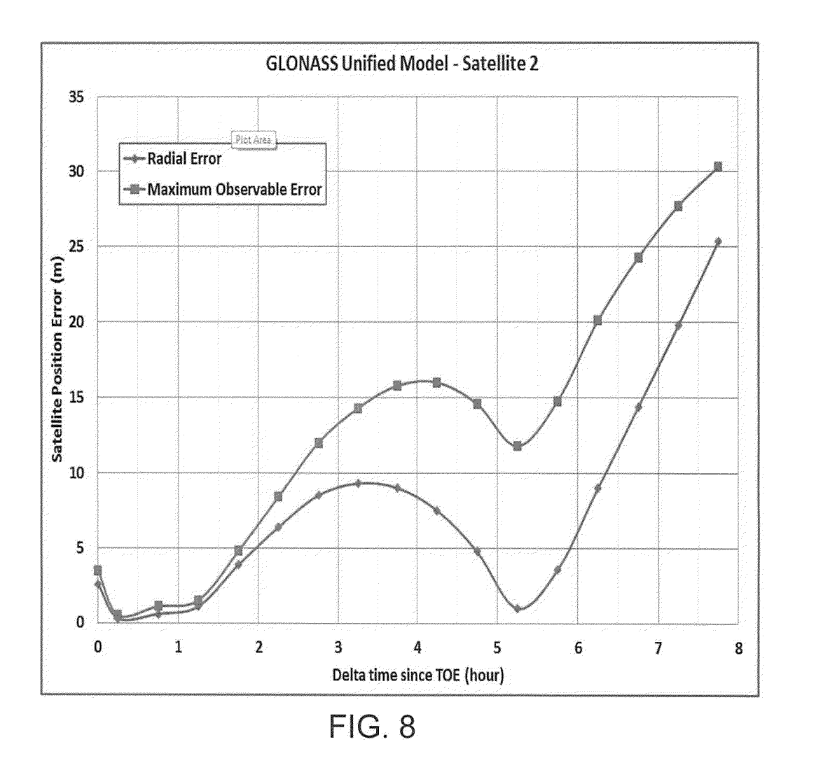

For the same satellites and time, position accuracy of Glonass unified ephemeris models is on the order of meters, as shown in FIG. 7 and FIG. 8.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the scope of the invention.

What is claimed is:

1. A method of deriving an accurate long-term orbital model parameter set for a non-GPS satellite that broadcasts native orbital model data specified as valid within a first time period, the method comprising:
determining initial position and velocity and acceleration data from the native orbital model data;
performing orbit integration to determine an orbital arc in an earth-centered-earth-fixed frame over a second time period longer than the first time period;
determining initial estimates of GPS or GPS-like orbit parameters for the non-GPS satellite;
inputting the orbital arc and the initial estimates of the GPS or GPS-like orbit parameters to an orbit parameter solver that determines GPS or GPS-like parameters that fit the orbital arc; and
using the orbit parameter solver to determine a final orbital model parameter set in GPS or GPS-like format for the non-GPS satellite.

2. The method of claim 1, wherein the non-GPS satellite is a Glonass satellite.

3. The method of claim 2, comprising performing orbit integration using a method different than a specified method specified in Glonass documentation such that the orbital model parameter set in GPS or GPS-like format for the non-GPS satellite provides greater positional accuracy over the second longer time period than if the specified method were used.

4. The method of claim 1, comprising, for each of a plurality of successive time periods:
performing orbit integration over a time period;
initializing the orbit solver with a GPS or GPS-like orbit model parameters for a preceding time period;
inputting orbit integration data for the time period to the orbit solver; and
using the parameter solver to obtain a GPS or GPS-like orbit model parameters for the time period.

5. The method of claim 1, wherein the initial position and velocity data for the non-GPS satellite are obtained from a native orbital model data transmission of the satellite.

6. The method of claim 5, comprising determining a rate of change of longitude parameter as one of the initial GPS format orbital model parameters for the non-GPS satellite using a method of trial and error.

7. The method of claim 6, comprising comparing: 1) a position of the non-GPS satellite at a specified time computed using the orbital model parameter set in GPS or GPS-like format for the non-GPS satellite in which a trial value of the rate of change of longitude parameter is used; with 2) a position of the non-GPS satellite at the specified time computed using native orbital model data.

8. The method of claim 1, wherein estimates at least some of the GPS or GPS-like orbit parameters for the non-GPS satellite are obtained from a non-native orbital model data transmission of the satellite.

9. A non-transitory computer-readable medium for deriving an accurate long-term orbital model parameter set for a non-GPS satellite that broadcasts native orbital model data specified as valid within a first time period, comprising instructions for:
determining initial position and velocity data from the native orbital model data;
performing orbit integration to determine an orbital arc in an earth-centered-earth-fixed frame over a second time period longer than the first time period;
determining initial estimates of GPS or GPS-like orbit parameters for the non-GPS satellite;
inputting the orbital arc and the initial estimates of the GPS or GPS-like orbit parameters to an orbit parameter solver that determines GPS or GPS-like parameters that fit the orbital arc; and
using the orbit parameter solver to determine a final orbital model parameter set in GPS or GPS-like format for the non-GPS satellite.

10. The apparatus of claim 9, wherein the non-GPS satellite is a Glonass satellite.

11. The apparatus of claim 10, comprising instructions for performing orbit integration using a method different than a specified method specified in Glonass documentation such that the orbital model parameter set in GPS or GPS-like format for the non-GPS satellite provides greater positional accuracy over the second longer time period than if the specified method were used.

12. The apparatus of claim 11, comprising instructions for, for each of a plurality of successive time periods:
performing orbit integration over the time period;
initializing the orbit solver with a GPS or GPS-like orbit model for a preceding time period;
inputting orbit integration data for the time period to the orbit parameter solver; and
using the orbit parameter solver to obtain a GPS or GPS-like orbit model parameters for the time period.

13. The apparatus of claim 9, comprising instructions for obtaining the initial position and velocity data for the non-GPS satellite from a native orbital model data transmission of the satellite.

14. The apparatus of claim 13, comprising instructions for determining a rate of change of longitude parameter as one of the initial GPS format orbital model parameters for the non-GPS satellite using a method of trial and error.

15. The apparatus of claim 14, comprising instructions for comparing: 1) a position of the non-GPS satellite at a specified time computed using the orbital model parameter set in GPS or GPS-like format for the non-GPS satellite in which a trial value of the rate of change of longitude parameter is used; with 2) a position of the non-GPS satellite at the specified time computed using native orbital model data.

16. The apparatus of claim 9, comprising instructions for obtaining at least some of the initial estimates of GPS or GPS-like orbit parameters for the non-GPS satellite from a non-native orbital model data transmission of the satellite.

17. A mobile electronic device for deriving an accurate long-term orbital model parameter set for a non-GPS satellite that broadcasts native orbital model data specified as valid within a first time period, comprising:
a navigation satellite receiver;
a processor coupled to the navigation satellite receiver; and
memory coupled to the processor and comprising instructions for:
determining initial position and velocity data from the native orbital model data;
performing orbit integration to determine an orbital arc in an earth-centered-earth-fixed frame over a second time period longer than the first time period;
determining initial estimates of GPS or GPS-like orbit parameters for the non-GPS satellite;
inputting the orbital arc and the initial estimates of the GPS or GPS-like orbit parameters to an orbit parameter solver that determines GPS or GPS-like parameters that fit the orbital arc; and
using the orbit solver to determine orbital model parameters in GPS or GPS-like format for the non-GPS satellite.

18. The apparatus of claim 17, wherein the non-GPS satellite is a Glonass satellite.

19. The apparatus of claim 18, wherein the memory comprises instructions for performing orbit integration using a method different than a specified method specified in Glonass documentation such that the orbital model parameter set in GPS or GPS-like format for the non-GPS satellite provides positional accuracy over the second longer time period greater than if the specified method were used.

20. The apparatus of claim 17, wherein the memory comprises instructions for, for each of a plurality of successive time periods:
performing orbit integration over the time period;
initializing the orbit solver with a GPS or GPS-like orbit model parameters for a preceding time period;
inputting orbit integration data for the time period to the orbit solver; and
using the orbit solver to obtain a GPS or GPS-like orbit model for the time period.

21. The apparatus of claim 17, wherein the memory comprises instructions for obtaining the initial position and velocity data for the non-GPS satellite from a native orbital model data transmission of the satellite.

22. The apparatus of claim 21, wherein the memory comprises instructions for determining a rate of change of longitude parameter as one of the initial GPS format orbital model parameters for the non-GPS satellite using a method of trial and error.

23. The apparatus of claim 22, wherein the memory comprises instructions for comparing: 1) a position of the non-GPS satellite at a specified time computed using the orbital model parameter set in GPS or GPS-like format for the non-GPS satellite in which a trial value of the rate of change of longitude parameter is used; with 2) a position of the non-GPS satellite at the specified time computed using native orbital model data.

24. The apparatus of claim 17, wherein the memory comprises instructions for obtaining at least some of the initial estimates of GPS or GPS-like orbit parameters for the non-GPS satellite from a non-native orbital model data transmission of the satellite.

25. A server for deriving an accurate long-term orbital model parameter set for a non-GPS satellite that broadcasts native orbital model data specified as valid within a first time period, comprising:
an interface for receiving navigation satellite receiver data;
a processor coupled to the interface; and
memory coupled to the processor and comprising instructions for:
determining initial position and velocity data from the native orbital model data;
performing orbit integration to determine an orbital arc in an earth-centered-earth-fixed frame over a second time period longer than the first time period;
determining initial estimates of GPS or GPS-like orbit parameters for the non-GPS satellite;
inputting the orbital arc and the initial estimates of the GPS or GPS-like orbit parameters to an orbit parameter solver that determines GPS or GPS-like parameters that fit the orbital arc; and
using the orbit parameter solver to determine for orbital model parameters in GPS or GPS-like format for the non-GPS satellite.

26. The apparatus of claim 25, wherein the non-GPS satellite is a Glonass satellite.

27. The apparatus of claim 26, wherein the memory comprises instruction for performing orbit integration using a method different than a specified method specified in Glonass documentation such that the orbital model parameter set in GPS or GPS-like format for the non-GPS satellite provides positional accuracy over the second longer time period greater than if the specified method were used.

28. The apparatus of claim 25, wherein the memory comprises instructions for, for each of a plurality of successive time periods:
performing orbit integration over the time period;
initializing the orbit solver with a GPS or GPS-like orbit model for a preceding time period;
inputting orbit integration data for the time period to the orbit solver; and
using the orbit parameter solver to obtain a GPS or GPS-like orbit model parameters for the time period.

29. The apparatus of claim 25, wherein the memory comprises instructions for obtaining the initial position and velocity data for the non-GPS satellite are obtained from a native orbital model data transmission of the satellite.

30. The apparatus of claim 29, wherein the memory comprises instructions for determining a rate of change of longitude parameter as one of the initial GPS format orbital model parameters for the non-GPS satellite using a method of trial and error.

31. The apparatus of claim 30, wherein the memory comprises instructions for comparing: 1) a position of the non-GPS satellite at a specified time computed using the orbital model parameter set in GPS or GPS-like format for the non-GPS satellite in which a trial value of the rate of change of longitude parameter is used; with 2) a position of the non-GPS satellite at the specified time computed using native orbital model data.

32. The apparatus of claim 25, wherein the memory comprises instructions for obtaining at least some of the initial estimates of GPS or GPS-like orbit parameters for the non-GPS satellite from a non-native orbital model data transmission of the satellite.
